(19) United States
(12) Patent Application Publication
(10) Pub. No.: US 2008/0119322 A1
(43) Pub. Date: May 22, 2008

(54) Vehicle Power Transmission

(76) Inventor: Edward Timothy Bishop, Northamptonshire (GB)

Correspondence Address: AMSTER, ROTHSTEIN & EBENSTEIN LLP, 90 PARK AVENUE, NEW YORK, NY, 10016, US

(21) Appl. No.: 11/661,959

(22) PCT Filed: Sep. 2, 2005
(86) PCT No.: PCT/GB05/03407

§ 371 Date: Jul. 25, 2007

(30) Foreign Application Priority Data
Sep. 2, 2004 (GB) 0419501.2

(51) Int. Cl. B60K 6/22; B60K 6/00

(52) U.S. Cl. 477/44; 180/69.6

(57) ABSTRACT

Power transmission apparatus (46) for mechanically transmitting motive power from a rotatable input shaft (21) to a rotatable output shaft (38), the apparatus comprising a linkage (28) connecting the input shaft to the output shaft such that rotation of the input shaft can cause rotation of the output shaft, the linkage being adjustable so that the transmission ratio can be continuously varied between a forward value and a reverse value.

This invention relates to transmission systems, especially transmission systems for conveying motive power in vehicles.

Vehicles that can develop motive power from more than one means (hybrid vehicles) are becoming increasingly significant due to their potential for energy efficiency. One particular form of hybrid has an internal combustion (IC) engine and an electric motor, and a transmission arrangement that allows the vehicle to be driven by one or both of those. One potential advantage of this arrangement is that the vehicle can save energy through regenerative braking, in which the vehicle is retarded by the electric motor acting as a generator. Energy generated in that way is stored in batteries and can subsequently be used to allow the motor to drive the vehicle. Another potential advantage of this arrangement is that the electric motor can be used to assist the internal combustion engine when the internal combustion engine is acting in a relatively inefficient part of its speed range, or requires supplementary power to boost the acceleration of the vehicle

A transmission arrangement provides the connection between each of the power sources and the means of driving the vehicle: typically the wheels. Two principal ways of connecting the IC engine and the electric motor have been proposed. In one, known as a parallel hybrid, the IC engine and the motor are connected to individual respective input shafts of a transmission that connects them to the wheels of the vehicle. In the other, known as a series hybrid, the motor is connected with a fixed transmission ratio to the crankshaft of the IC engine, which is connected via a transmission to the wheels.

A parallel hybrid has the disadvantages that it is generally relatively bulky, as to run the vehicle at any speed from either of the power sources requires a correspondingly bigger electric (or alternative) power-source. Also it normally requires complex electronics or a complex mechanical arrangement to allow seamless transition through the full range of combinations of the power sources.

A series hybrid has a number of disadvantages. In particular it is difficult to optimise the drive ratio between the motor and the IC engine for the full range of speeds of the IC engine. This normally results in it having lower efficiency than a parallel hybrid. When the IC engine is running at a low speed it is relatively inefficient, and it would be desirable for it to be assisted by the motor. If at that point the motor is at a low speed then in order to produce sufficient torque it will have to draw a high current. That calls for a larger motor and heavy electrical connections. A high current draw can also shorten the life of the batteries. However, if the drive ratio is set to overcome that, the motor can be operating at excessive speed when the IC engine reaches its highest speed. And the torque output from the electric motor has long since vanished, so no assistance is available in the mid-range.

One form of transmission unit that has been used in various applications is a continuously variable transmission (CVT) unit. A CVT unit has a one input/one output pair of input/output shafts which are interconnected by a mechanism that allows the gearing ratio between the two shafts to be continuously adjusted. In comparison to conventional gearboxes, known CVT units have the advantage that the gearing ratio can be adjusted continuously, rather than in steps corresponding to the available gears. However, a separate clutch and reversing box are generally used if the unit is to drive an output shaft in either direction, or to isolate one shaft from the other, both of which are possible with conventional gearboxes.

There is therefore a need for an improved form of transmission, especially but not exclusively for transmission of power between an electric motor and an IC motor in a series hybrid application.

According to one aspect of the present invention there is provided power transmission apparatus for mechanically transmitting motive power from a rotatable input shaft to a rotatable output shaft, the apparatus comprising a linkage connecting the input shaft to the output shaft such that rotation of the input shaft can cause rotation of the output shaft, the linkage being adjustable so that the transmission ratio can be continuously varied between a forward value and a reverse value.

The linkage preferably comprises a differential having first and second rotatable input shafts and a rotatable output shaft, whereby the speed and direction of rotation of the output shaft of the differential is determined by the relative rotation of the first and second input shafts of the differential. The linkage preferably further comprises a pair of parallel drive trains connecting the input shaft to the first and second input shafts of the differential. The parallel drive chains may be arranged such that rotation of the said input shaft in a first direction leads to rotation of the first input shaft of the differential in the first direction and rotation of the second input shaft of the differential in a second, opposite direction. Preferably one of the drive trains comprises a continuously variable transmission unit for continuously varying the speed of rotation of one of the first and second input shafts of the differential relative to the speed of rotation of the said input shaft.

According to a second aspect of the present invention there is provided a system comprising: power transmission apparatus according to any preceding claim; a first power source; a second power source; and drive means; wherein the first power source is connected to the drive means and the second power source is connected to the drive means via the power transmission apparatus whereby the relative transmission ratios of the first power source and the second power source to the drive means can be varied.

According to a third aspect of the present invention there is provided a powerplant comprising: first and second power sources; an output for supplying motive power to a drive means; and a transmission arrangement whereby the first and second power sources are connected to the output so as to be capable of powering the output, the transmission arrangement being arranged in such a way that both of the power sources can power the output at the same time, and the transmission arrangement having means for varying the relative transmission ratios of the first and second power sources to the output.

The powerplant preferably comprises a control unit for controlling the transmission arrangement to vary. Preferably the control unit has one or more inputs and is arranged to vary the relative transmission ratios of the first power source to the output in dependence on the one or more inputs. Preferably the control unit inputs include: a sensor for sensing the setting of an accelerator control operable to vary the power supplied by one or both of the first and second power sources; or a sensor for sensing the setting of a brake control operable to cause deceleration of the vehicle. Preferably one of the first and second power sources is an internal combustion engine, and the control unit inputs include a speed sensor for sensing the speed of the engine. Preferably the control unit is arranged so as to control the transmission unit to maintain one of the first and second power sources within a predetermined speed range.

Preferably the first and second power sources are of different types. Either of the first and second power sources may be an electric motor. The other of the first and second power sources may be an internal combustion engine. Other forms of power source may be used. Where the power sources are an electric motor and an internal combustion engine the output of the electric motor is preferably connected to a crankshaft of the engine via the transmission arrangement, and to the drive means (e.g. wheels) of the vehicle via the crankshaft. Preferably the motor is arranged so that it cannot power the drive means without the engine rotating.

The present invention will now be described by way of example with reference to the accompanying drawings. In the accompanying drawings:

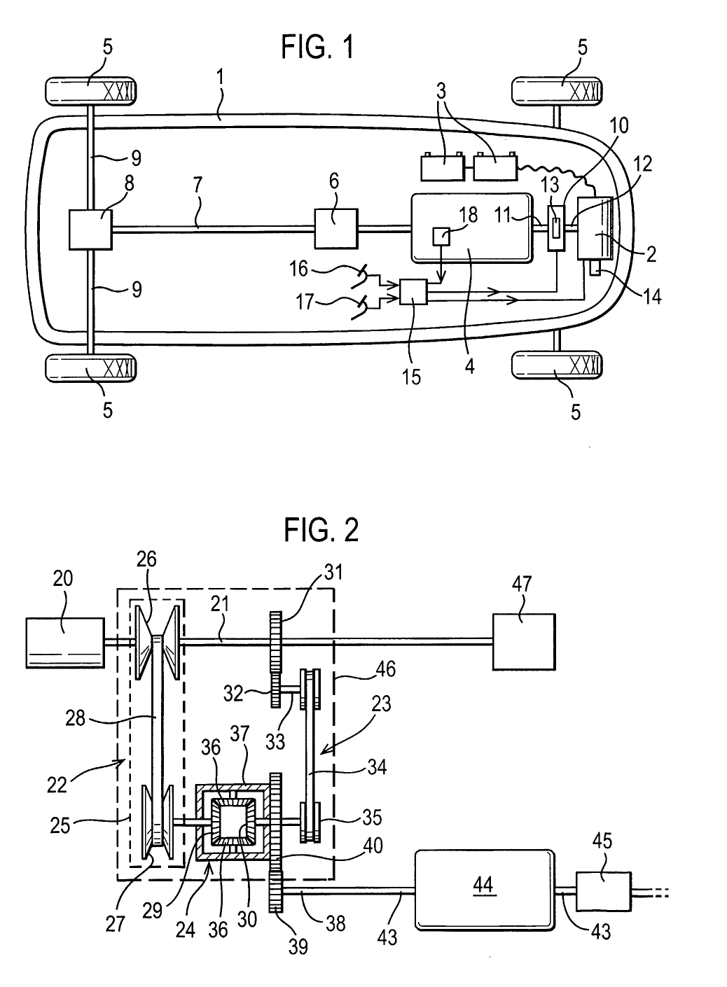

FIG. 1 is a schematic diagram of a vehicle having a first transmission system;

FIG. 2 is a schematic diagram of a second transmission system.

FIG. 1 shows a vehicle having a chassis 1 that carries an electric motor 2, batteries 3 and an internal combustion engine 4. The chassis is borne on wheels 5 by means of which it can be driven to move. The crankshaft of the internal combustion engine is connected to the wheels through a gearbox 6, drive shaft 7 differential 8 and axles 9 in the normal way. The crankshaft is also connected to the output shaft of motor 2 via a transmission unit 10. Thus the IC engine 4 and the motor 2 are connected in series.

The transmission unit 10 is a continuously variable transmission unit. It has first and second drive shafts 11, 12 by means of which it can be connected to other equipment. Inside the transmission unit the first and second shafts are coupled together by a mechanism 13 that allows the transmission ratio between the two shafts to be continuously varied. Examples of suitable mechanisms are described below. In the context of the present description, a forward value of a transmission ratio refers to an arrangement in which the rotation directions of the first and second shafts is the same, and a reverse value indicates that the rotation of the first shaft is opposite that of the second shaft.

The interaction between the motor 2 and the engine 4 can be controlled by means of the transmission unit 10, electrical control gear 14 associated with the motor and optionally a clutch that could be located between the motor and the engine.

The vehicle has a management unit 15 which controls the operation of the IC engine 4, the motor 2, the transmission unit 10 and the clutch (if present). The management unit operates in accordance with inputs received from an accelerator pedal 16, a brake pedal 17 and sensors including a speed sensor 18 for sensing the speed of the IC engine. When the accelerator pedal is pressed so as to cause the vehicle to accelerate the management unit adopts a drive mode and controls the IC engine and/or the motor to provide power so as to cause the vehicle to accelerate, and sets the transmission ratio of the transmission unit, in accordance with a drive strategy pre-programmed into the transmission unit. Under deceleration and close throttle (such as during gear-shifting) conditions the management unit adopts a drive mode and controls the IC engine and/or the motor not to provide power so as to cause the vehicle to decelerate, and sets the transmission ratio of the transmission unit, in accordance with a drive strategy pre-programmed into the transmission unit to cause regenerative charge. When the brake pedal is pressed so as to cause the vehicle to decelerate the management unit adopts a further regeneration mode and controls the motor to act to generate extra electrical energy from rotation of its output shaft as driven by the wheels. This causes the vehicle to decelerate. The electricity that is generated in this way is stored in the batteries 3 for later use. The retardation of the vehicle can be assisted by brakes operated by the brake pedal, which are not shown in FIG. 1.

Instead of using an electronic control system the transmission unit could be mechanically controlled, for example by means of rotating spring bob-weights.

A number of strategies may be employed for controlling the IC engine, the motor and the transmission unit. In one example, during the drive mode the management unit sets the transmission ratio of the transmission unit in dependence on the speed of the IC engine so that as the speed of the IC engine increases the transmission ratio alters so that the motor makes fewer revolutions for each revolution of the IC engine. For example, when the IC engine is at low speed (e.g. 1000 rpm) the transmission ratio could be 3:1, so that the electric motor makes three revolutions for each revolution of the IC engine. When the IC engine is at high speed (e.g. 6000 rpm) the transmission ratio could be 1:2 so that the IC engine makes two revolutions for each revolution of the electric motor. This is an ideal situation to extract the most efficient torque assist from the electric drive under acceleration conditions. The ratios reverse under re-generation conditions, speeding the electric motor in relation to the IC motor and generating maximum regeneration (and therefore deceleration) with less resort to the usual friction brakes. As a result, a series hybrid as described herein can provide more efficient torque drive and regeneration than a conventional series hybrid, whilst avoiding the weight, bulk and complexity generally associated with parallel hybrid designs. Preferably the speed of the electric motor is kept relatively constant, most preferably within its own best efficiency range, independent of the speed of the IC engine, when the IC engine is in its operating speed range.

This arrangement has a number of beneficial effects arising from the nature of typical motors and IC engines. IC engines are typically relatively inefficient at low speeds. On the other hand, an electric motor typically produces constant power across its speed range and so to develop considerable torque at low speeds would require a large motor, which would draw a high current. Such a motor would be heavy, would require heavy cabling to handle the current it would draw, and the high current load could reduce the life of the batteries. The strategy described above allows these problems to be addressed. At low speeds of the IC engine it allows the motor to run at a higher speed than the IC engine. This means that the motor can develop sufficient power to supplement the IC engine without drawing excessive current. At high speeds of the IC engine it allows the motor to run at a lower speed than the IC engine, which maintains the output of the electric motor. Thus the motor can provide relatively efficient drive assistance throughout the speed range of the IC engine.

In the regeneration mode the management unit or optionally the mechanics of the CVT itself (e.g. when provided with a mechanical control arrangement) preferably sets the transmission ratio of the transmission unit 10 so that the motor is driven at a relatively high speed irrespective of the speed of the IC engine. This can greatly increase the effectiveness of the deceleration charging compared to running the motor at a relatively low speed.

The transmission unit 10 need not be a continuously variable transmission unit. However, a continuously variable transmission unit has the advantages that the relative speeds of the motor and the IC engine can be optimised, and that it avoids interruption of the power train during gear changes.

FIG. 2 shows an alternative type of transmission unit. In this arrangement the motor 20 has an output shaft 21 which is connected via two transmission routes 22, 23 to a differential 24.

In the first route 22 there is a continuously variable transmission (CVT) unit 25. In this example the CVT unit is a V-pulley belt drive unit, but other types of CVT unit can be used, as described below. The CVT unit 25 comprises first and second V-pulleys 26, 27 with a drive belt 28 passing between them. Each of the V-pulleys is made up of a pair of conical plates which can be moved together or apart to change the effective radius of the pulleys. As a result, the drive ratio between the pulleys can be varied. One of the pulleys is attached to the output shaft 21. The other of the pulleys is attached to one of the sun gears 29 of the differential 24.

In the second route 23 the output shaft 21 is connected in a fixed drive ratio to the other of the sun gears 30 of the differential. The direction of rotation of the other sun gear must be opposite to that of the first sun gear. To achieve this a gear 31 on the output shaft drives a gear 32 on a lay shaft 33. A pulley on the lay shaft 33 drives a belt 34 which runs over a pulley 35 which is attached to the other sun gear 30. The drive ratio of the second route is preferably around the middle of the range of drive ratios that can be provided by the CVT unit 25.

The differential is arranged in the conventional way. A pair of planet gears 36 mesh with the sun gears 29, 30. The planet gears are attached to a casing 37 which can rotate about the same axis as the sun gears. The output of the system is taken from the exterior of the casing by means of a drive shaft 38 bearing a pinion 39 which engages with a drive gear 40 which is carried by the casing.

The shaft 21 could conveniently pass through the motor 20 and the connections to the first and second routes could be made to it on opposite sides of the motor.

In the arrangement of FIG. 2, if the CVT unit 25 is set so that the drive ratio of the first route 22 is the same as that of the second route 23, the planet gears will be driven in balance and the casing will remain static. If the CVT unit is set so that the drive ratio of the first route 22 is different from that of the second route 23, the planet gears will drive the casing 37 to rotate in a direction and at a speed that depend on the setting of the CVT unit. Thus, this arrangement provides a means whereby the drive ratio between the motor 20 and the drive shaft 38 can be widely varied in either direction, and furthermore in which the drive shaft 38 can be isolated from rotation of the motor (when the planet gears are in balance). Normally a gearbox would be required to allow for relative rotation in either direction, and a clutch would be required to allow for isolation between shafts 21 and 38.

In the embodiment of FIG. 2, the drive shaft 38 is coupled by a pair of gears 41, 42 (not shown) to the crankshaft 43 of an internal combustion engine 44. The crankshaft 43 passes to a gearbox 45 from which a drive passes to the wheels of a vehicle in the normal way.

In this embodiment the variable ratio unit 46, which comprises the transmission routes 22, 23 and the differential 24, provides a convenient means whereby the drive ratio between the internal combustion engine 44 and the electric motor 20 can be varied for achieving the advantages identified above in relation to the embodiment of FIG. 1. One further advantage of the arrangement of FIG. 2 is that it allows the internal combustion engine to be entirely isolated from the motor without the need for a clutch, so that the engine can run with no losses from the motor with no need to hold a clutch disengaged. This mode is especially useful when the engine is running at high speed. Another advantage of the arrangement of FIG. 2 is that the interaction between the motor and the engine can be very simply controlled by means of the CVT unit 25, potentially so that the electric motor runs at a constant speed when driving. This reduces the need for more complex electrical control units that might be required if the motor is intended to operate at a range of speeds. Also, the electric motor can be varied between a much greater range of speeds, thus significantly enhancing its output and its regenerative capabilities. The electric motor could especially be used as the sole power source at low speed and when reversing, with the petrol engine switched off, since this would allow for slow and inch-perfect manoeuvres to be achieved.

In operation the CVT unit 25 would be controlled by a transmission management unit analogous to unit 15 in FIG. 1 or alternatively by a mechanical control arrangement, for instance using sprung bob-weights. It would control the supply of current to, or the draw of current from, the motor 20, and the settings of the pulleys 26, 27 so as to set the drive ratio of the CVT unit 22.

A variable ratio unit of the type shown in the figures could be used in other applications, for example as a variable ratio transmission unit between an internal combustion engine and drive means such as wheels, or in any other applications where an input shaft is to drive an output shaft with a variable drive ratio between them. It provides significant advantages over simply a conventional CVT unit in that it can allow isolation of one shaft from the other and interconnection of the shafts in both forward and reverse directions.

There are numerous ways of arranging a continuously variable transmission ratio unit suitable for acting as either of units 10 and 25 in the figures. Examples include variable ratio belt-and-pulley mechanisms, belt-and-cone mechanisms and viscous fluid toroidal mechanisms.

The arrangements described above could be used in vehicles such as cars, trucks, boats and helicopters, and in fixed drive installations. The order of the series connection between the IC engine and the motor could be reversed from that illustrated.

The system of FIG. 2 further includes an air conditioning unit 47 driven from the output shaft 21 of the motor 20. Depending on the setting of the CVT unit 25 the air conditioning unit can be connected to or isolated from the internal combustion engine 44. If the CVT unit is set so that the motor 20 and hence the air conditioning unit 47 are isolated from the engine 44 the air conditioning unit can be driven by the motor 20 even when the engine is stopped, although it can be driven by the engine 44 when no power is being supplied to the motor 20 and the CVT unit 25 is set appropriately. This has a number of useful applications. First, to save energy it is common for hybrid vehicles to stop the IC engine when the vehicle is stationary, for example standing in traffic. In that situation the CVT unit 25 could be set to disconnect the IC engine from the air conditioning unit, and the air conditioning unit could be driven by the motor 20. Second, the air conditioning could be driven by the motor 20 even when the vehicle is not being driven. The transmission management system could automatically set the CVT unit 25 to disconnect the IC engine from the air conditioning unit and then cause the motor to start to drive the air conditioning. Examples of the situations in which this could happen are if the user signals the vehicle from a remote control device, if a timer in the vehicle reaches a pre-set time, or if the temperature inside the car exceeds a pre-set value. When the system of FIG. 1 is provided with a clutch or other means of isolating the motor 2 from the engine 4, a similar arrangement can be implemented.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. Power transmission apparatus for mechanically transmitting motive power from a rotatable input shaft to a rotatable output shaft, the apparatus comprising a linkage connecting the input shaft to the output shaft such that rotation of the input shaft can cause rotation of the output shaft, the linkage being adjustable so that the transmission ratio can be continuously varied between a forward value and a reverse value.

2. Power transmission apparatus according to claim 1 wherein the linkage comprises a differential having first and second rotatable input shafts and a rotatable output shaft, whereby the speed and direction of rotation of the output shaft of the differential is determined by the relative rotation of the first and second input shafts of the differential.

3. Power transmission apparatus according to claim 2 wherein the linkage further comprises a pair of parallel drive trains connecting the input shaft to the first and second input shafts of the differential.

4. Power transmission apparatus according to claim 3 wherein the parallel drive trains are arranged such that rotation of the said input shaft in a first direction leads to rotation of the first input shaft of the differential in the first direction and rotation of the second input shaft of the differential in a second, opposite direction.

5. Power transmission apparatus according to claim 4 wherein one of the drive trains comprises a continuously variable transmission unit for continuously varying the speed of rotation of one of the first and second input shafts of the differential relative to the speed of rotation of the said input shaft.

6. A system comprising:
power transmission apparatus for mechanically transmitting motive power from a rotatable input shaft to a rotatable output shaft, the apparatus comprising a linkage connecting the input shaft to the output shaft such that rotation of the input shaft can cause rotation of the output shaft, the linkage being adjustable so that the transmission ratio can be continuously varied between a forward value and a reverse value;
a first power source;
a second power source; and
drive means;
wherein the first power source is connected to the drive means and the second power source is connected to the drive means via the power transmission apparatus whereby the relative transmission ratios of the first power source and the second power source to the drive means can be varied.

7. A powerplant comprising:
first and second power sources;
an output for supplying motive power to a drive means; and
a transmission arrangement whereby the first and second power sources are connected to the output so as to be capable of powering the output, the transmission arrangement being arranged in such a way that both of the power sources can power the output at the same time, and the transmission arrangement having means for varying the relative transmission ratios of the first and second power sources to the output.

8. A powerplant according to claim 7 further comprising a control unit for controlling the transmission arrangement to vary.

9. A powerplant according to claim 8 wherein the control unit has one or more inputs and is arranged to vary the relative transmission ratios of the first power source to the output in dependence on the one or more inputs.

10. A powerplant according to claim 9 installed in a vehicle, wherein the control unit inputs include: a sensor for sensing the setting of an accelerator control operable to vary the power supplied by one or both of the first and second power sources; or a sensor for sensing the setting of a brake control operable to cause deceleration of the vehicle.

11. A powerplant according to claim 9 wherein one of the first and second power sources is an internal combustion engine, and the control unit inputs include a speed sensor for sensing the speed of the engine.

12. A powerplant according to claim 8, wherein the control unit is arranged so as to control the transmission unit to maintain one of the first and second power sources within a predetermined speed range.

13. A powerplant according to claim 7 wherein one of the first and second power sources is an electric motor.
